(19) United States
(12) Patent Application Publication
(10) Pub. No.: US 2003/0143320 A1
(43) Pub. Date: Jul. 31, 2003

(54) Light diffuser fabrication method

(75) Inventors: Cheng-Chung Lee, Hsin-Shi (TW); Jin-Cherng Hsu, Hsin-Shi (TW)

Correspondence Address: BRUCE H. TROXELL, Suite 1404, 5205 Leesburg Pike, Falls Church, VA, 22041, US

(73) Assignee: Cheng-Chung LEE

(21) Appl. No.: 10/058,501

(22) Filed: Jan. 30, 2002

(51) Int. Cl. B05D 3/02; B05D 5/12; B05D 1/18

(52) U.S. Cl. 427/66; 427/387; 427/430.1

(57) ABSTRACT

A light diffuser fabrication method includes the step of (a) selecting sands for blasting subject to the size of spot light source and number of pixels of the display to be used, (b) sand blasting a glass substrate with selected sands to form a multi-frequency refracting substrate, (c) coating the multi-frequency refracting substrate with polysiloxane by bathing, (d) baking the polysilixane coated multi-frequency refracting substrate into the desired light diffuser.

### BACKGROUND OF THE INVENTION

1. Field of the Invention

The present invention relates a light diffuser fabrication method and more particularly, to such a light diffuser fabrication method, which is practical for making a light diffuser that diffuses interrupted light spots into continuous spot light sources.

2. Description of the Related Art

LEDs (light emitting diodes) are commonly used for making a display panel for showing characters, patterns, etc., for advertising or the like. However, the light rays emitted from a LED display panel are interrupted.

### SUMMARY OF THE INVENTION

It is one object of the present invention to provide a light diffuser fabrication method, which is simple and effective. It is another object of the present invention to provide a light diffuser fabrication method, which is practical for making light diffusers that produce a multi-frequency refracting effect. The light diffuser fabrication method of the invention includes the step of (a) selecting sands for blasting subject to the size of spot light source and number of pixels of the display to be used, (b) sand blasting a glass substrate with selected sands to form a multi-frequency refracting substrate, (c) coating the multi-frequency refracting substrate with polysiloxane by bathing, (d) baking the polysilixane coated multi-frequency refracting substrate into the desired light diffuser.

### BRIEF DESCRIPTION OF THE DRAWINGS

FIG. 1 is a block diagram explaining the procedure of the light diffuser fabrication method according to the present invention.

FIG. 2 is a sectional view of a light diffuser made according to the present invention.

FIG. 3 is a schematic drawing showing an application example of the present invention and an application example of the prior art design.

### DETAILED DESCRIPTION OF THE PREFERRED EMBODIMENT

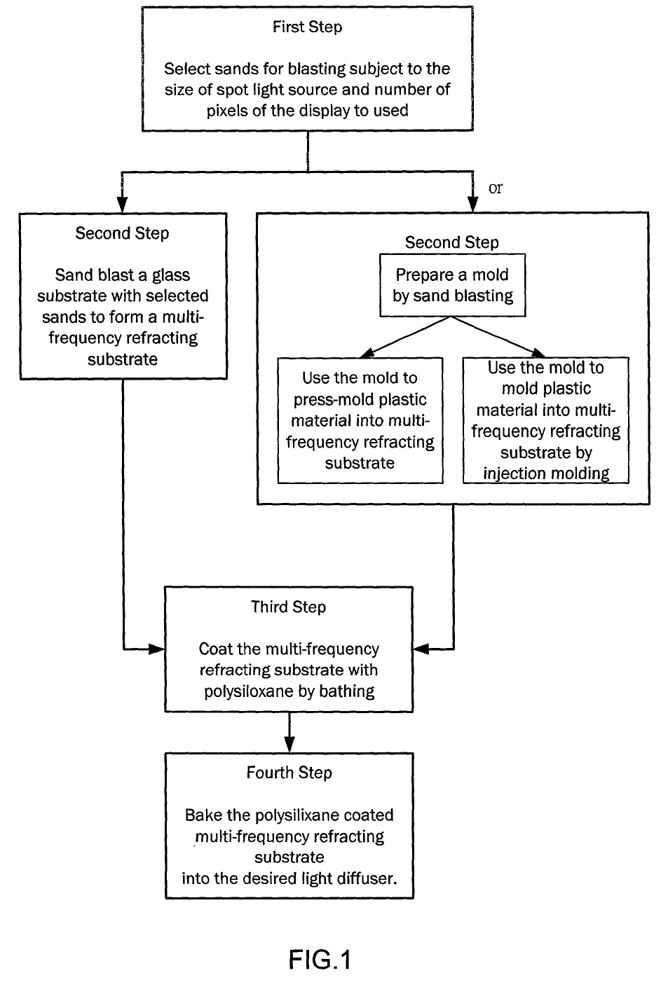

Referring to FIG. 1, a light diffuser fabrication method in accordance with the present invention includes four steps.

The first step is to select the size of sands for blasting subject to the number of light spots per inch based on the size of spot light source and number of pixels of the display to be used.

The second step is to produce a multi-frequency refracting substrate by: preparing a glass substrate and then blasting the selected sands onto the surface of the glass substrate. Alternatively, a multi-frequency refracting substrate can be made by: preparing a mold having a cavity subject to the dimension of the desired multi-frequency refracting substrate, and then sand-blasting the surface of the cavity of the mold, and then using the mold to produce the desired multi-frequency refracting substrate through an injection molding machine. The material used for injection molding can be polycarbonate or polystyrene. The refracting power of a multi-frequency refracting substrate made according to the aforesaid procedure is within about 1.56˜1.58 under visible light of wavelength 550 nm.

The third step is a solution bathing process where the prepared multi-frequency refracting substrate is dipped in polysiloxane solution in a bath at temperature within about 5° C.˜18° C., for enabling the multi-frequency refracting substrate to be covered with a layer of polysiloxane.

The fourth step is a baking process where the polysilixane coated multi-frequency refracting substrate is backed at 80° C. for about 90 minutes, and then backed at 125° C. for about 15 minutes. After baking, the polysilixane coating is curled, forming a layer of oxidized silicon coating 3 on the multi-frequency refracting substrate, and the desired light diffuser is thus obtained. The chemical bond of the oxidized silicon coating 3 is —O—Si—O—Si—O—. The refracting power of the oxidized silicon coating 3 under wavelength 550 nm is within about 1.47˜1.5.

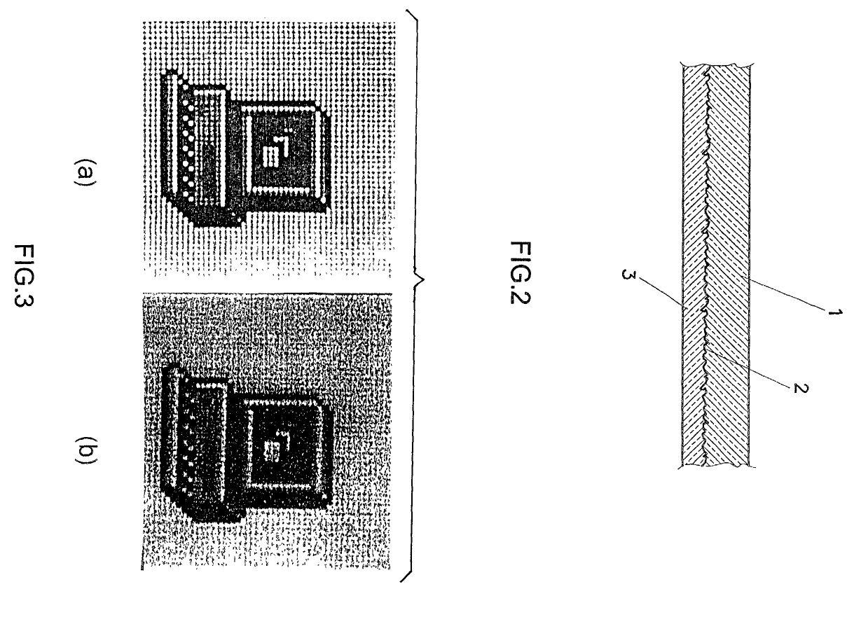

Referring to FIG. 2, a light diffuser made subject to the aforesaid fabrication method comprises a substrate 1 having a coarse surface 2, and an oxidized silicon coating 3 covering the coarse surface 2 of the substrate 1. The refracting power of the oxidized silicon coating 3 is lower than the coarse surface 2 of the substrate 1, but higher than the refracting power of dielectrics in the air. The evenly distributed coarse surface 2 of the substrate 1 achieves an multi-frequency refracting effect, for enabling spot light source to be evenly diffused. Because the refracting power of the materials at two sides of the coarse surface 2 is relatively lower than the coarse surface 2, the light diffuser eliminates excessive light diffusion effect, enables light to pass through the coarse surface and interrupted light spots to form a continuous light source. When used in digital video process, a real smooth image can be produced without causing an image distortion.

FIG. 3 is a schematic drawing showing an application example of the present invention and an application example of the prior art design. FIG. 3(a) illustrates the image of spot light source. FIG. 3(b) illustrates the image processed through the light diffuser of the present invention, which eliminates the image of interrupted blocks and characters as shown on FIG. 3(a).

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A light diffuser fabrication method comprising the steps of:
(a) selecting the sizes of sands subject to the number of light spots per inch counted subject to the size of spot light source and number of pixels of the display to be used;
(b) preparing a glass substrate and then blasting the selected sands onto the surface of the glass substrate to form a multi-frequency refracting substrate of refracting power within about 1.56˜1.58 under wavelength 550 nm;
(c) dipping the multi-frequency refracting substrate thus obtained in polysiloxane solution in a bath at temperature within about 5° C.˜18° C., for enabling the multi-frequency refracting substrate to be covered with a layer of polysiloxane; and
(d) baking the polysilixane coated multi-frequency refracting substrate thus obtained at 80° C. for about 90 minutes, and then backing the polysilixane coated multi-frequency refracting substrate at 125° C. for about 15 minutes, causing the polysilixane coating to be curled and formed into a layer of oxidized silicon coating of chemical bond —O—Si—O—Si—O— and of refracting power within about 1.47˜1.5 under wavelength 550 nm on the multi-frequency refracting substrate

2. The light diffuser fabrication method comprising the steps of:
(a) selecting the sizes of sands subject to the number of light spots per inch counted subject to the size of spot light source and number of pixels of the display to be used;
(b) preparing a mold having a cavity, and then sand-blasting the surface of the cavity of the mold, and then using the mold to produce a desired multi-frequency refracting substrate of refracting power within about 1.56˜1.58 under wavelength 550 nm;
(c) dipping the multi-frequency refracting substrate thus obtained in polysiloxane solution in a bath at temperature within about 5° C.˜18° C., for enabling the multi-frequency refracting substrate to be covered with a layer of polysiloxane; and
(d) baking the polysilixane coated multi-frequency refracting substrate thus obtained at 80° C. for about 90 minutes, and then backing the polysilixane coated multi-frequency refracting substrate at 125° C. for about 15 minutes, causing the polysilixane coating to be curled and formed into a layer of oxidized silicon coating of chemical bond —O—Si—O—Si—O— and of refracting power within about 1.47˜1.5 under wavelength 550 nm on the multi-frequency refracting substrate
